(19) United States
(12) Patent Application Publication
(10) Pub. No.: US 2013/0088970 A1
(43) Pub. Date: Apr. 11, 2013

(54) METHODS AND APPARATUS FOR ROUTER-TO-RADIO FLOW CONTROL

(71) Applicants: Mu-Cheng Wang, Acton, MA (US); Steven A. Davidson, Acton, MA (US); Sam Mohan, Groton, MA (US)

(72) Inventors: Mu-Cheng Wang, Acton, MA (US); Steven A. Davidson, Acton, MA (US); Sam Mohan, Groton, MA (US)

(73) Assignee: Raytheon Company, Walham, MA (US)

(21) Appl. No.: 13/269,100

(22) Filed: Oct. 7, 2011

(51) Int. Cl. H04W 28/02

(52) U.S. Cl. 370/236

(57) ABSTRACT

Methods and apparatus for transmitting, from a radio, over a router-to-radio interface, a first transmission-on signal indicating to a router that data packets can be sent to the radio for transmission in a network, and transmitting, from the radio over the router-to-radio interface, a first transmission-off signal indicating to the router that data packet transmission should be suspended until receipt of a second transmission-on signal, wherein the first transmission-on signal and the first transmission-off signal are generated in a network layer of the seven-layer OSI model.

### BACKGROUND

As is known in the art, there are a variety of conventional systems to provide versatile and reliable transport of data, voice and video traffic. Some organizations deploy complex communications systems that integrate terrestrial, airborne, and space-based platforms. In these communication systems, typically wireless networks, communications/network radio (hereafter simply “radio”) interface with hardware/software machines that perform an IP routing function (hereafter simply “routers”) at the sub-network boundaries to form a contiguous network infrastructure.

Wireless sub-systems employed in such communications networks are susceptible to time-varying link quality due to dynamic network conditions. In such situations, ordinary routers are unaware of the quality of the wireless links, resulting in problems with network flow-control and link-state detections. In the end, this problem leads to suboptimal operations of the network as a whole.

### SUMMARY

In one aspect of the invention, a method comprises a radio transmitting, over its router interface, a first transmission-on signal indicating to a router that data packets can be sent to the radio for transmission in a network, and transmission, by the radio, a first transmission-off signal indicating to the router that data packet transmission should be suspended until receipt of a second transmission-on signal, wherein the first transmission-on signal and the first transmission-off signal are generated in the network layer of the seven-layer OSI model.

The method can further include one or more of the following features: storing, in the radio, a remainder of a packet transmitted by the router after the first transmission-off signal was transmitted by the radio, buffering data from the router for transmission to an antenna, sizing a buffer for buffering the data from the router to receive complete packets, and/or configuring the radio for Mobile Ad-hoc Network (MANET) operation, the first transmission-off signal indicates that a buffer in the radio will overflow if the sender does not stop transmitting packets. In one embodiment, the radio does not transmit link quality information to the router.

In another aspect of the invention, a communication system comprises a radio comprising: a router interface, a buffer to buffer data from the router, an antenna interface to receive data from the buffer or directly as a pass-through from the radio, and a flow control mechanism to generate a first transmission-on signal indicating to the router that data packets can be sent to the radio and a first transmission-off signal indicating to the router that data packet transmission should be suspended until receipt of a second transmission-on signal, wherein the flow control mechanism is located in the network layer of the seven-layer OSI model.

The system can further include one or more of the following features: the communication system comprises a Mobile Ad-hoc Network (MANET) network, the buffer is sized to store complete packets, and/or the first transmission-off signal indicates that a buffer in the radio will overflow.

In a further aspect of the invention, an article comprises computer readable medium including non-transitory stored instructions that enable a machine to perform: after receiving from a radio, a first transmission-on signal indicating to a router that data packets can be sent to the radio for transmission in a network, and receiving from the radio, a first transmission-off signal indicating to the router that data packet transmission should be suspended until receipt of a second transmission-on signal, wherein the first transmission-on signal and the first transmission-off signal are generated in the network layer of the seven-layer OSI model.

The article can further include one or more of the following features: instructions for storing, in the radio, a remainder of a packet transmitted by the router after the first transmission-off signal was transmitted by the radio, instructions for buffering data from the router for transmission to an antenna, instructions for sizing a buffer for buffering the data from the router to receive complete packets, instructions for configuring the radio for Mobile Ad-hoc Network (MANET) operation, and/or the first transmission-off signal indicates that a buffer in the radio will overflow.

### BRIEF DESCRIPTION OF THE DRAWINGS

The foregoing features of this invention, as well as the invention itself, may be more fully understood from the following description of the drawings in which:

FIG. 1 is a schematic representation of an exemplary network having a router-to-radio flow control mechanism in accordance with exemplary embodiments of the invention;

FIG. 1A is a high-level block diagram showing an exemplary radio having a flow control mechanism in accordance with exemplary embodiments of the invention;

FIG. 2 is a schematic representation of prior art router-to-radio flow communication in accordance with RFC 5578;

FIG. 2A is a diagram of the well-known OSI model;

FIG. 3 is a schematic representation of prior art time division multiplexing;

FIG. 4 is a graphical representation of prior art router-radio communication;

FIG. 5 is a graphical representation of credit size versus credit count for the router-radio communication of FIG. 4;

FIG. 6 is a graphical representation of flow control communication in accordance with exemplary embodiments of the invention

FIGS. 7 and 7A are flow diagrams showing an exemplary sequence of steps for router-to- radio flow control in accordance with exemplary embodiments of the invention

FIG. 8 is a schematic representation of a computer that can perform at some processing in accordance with exemplary embodiments of the invention.

### DETAILED DESCRIPTION

Exemplary embodiments of the present invention provide a flow control mechanism for regulating bandwidth usage between routers and radios. In one embodiment, an inventive flow control mechanism can replace portions of the RFC 5578 protocol. The inventive flow control mechanism can eliminate certain packet losses and/or performance problems encountered with RFC 5578, and remove the requirement for resource-tracking by the routers and radios.

Before describing exemplary embodiments of the invention, some information is provided. The known IETF RFC 5578 addresses flow control with a router-to-radio interface protocol standard. This protocol, based on a supplier-consumer model, arbitrates bandwidth between the time-invariant throughput found in the Ethernet interface and the time-varying link capacity of the RF (radio frequency) link. Specifically, this protocol manages RF link utilization by employing a flow-control mechanism resulting in rapid link state detection on the RF links that allows the router to attempt to make an informed decision based on known link cost.

While IETF RFC 5578 may provide adequate RF link utilization in some networks, this protocol can cause packet loss and/or degraded router performance under high data rate conditions. This is due to the protocol need for frequent credit updates between router and the radio, as well as significant buffer space in the radio.

Protocols used by Internet routers to exchange information about the connections between networks are well known. Routers understand the specific attributes of each network, such as bandwidth, delay times, and multicast/broadcast capability. Routers take that information into consideration when deciding how to route a packet to its destination accurately and efficiently.

Some organizations need reliable and versatile tactical networks for data, voice, and video communications. Extending the existing wired networks to a dynamically changing environment, such as tactical military networks can be challenging. Since wireless networks are commonplace in most tactical networks, the routers need to take into consideration aspects of radio networks that are different from wired network technologies. For example, even in a small tactical network, the range, signal strength, type of antenna, and other attributes of radio systems can vary widely. Moreover, radios can constantly change their location which rapidly alters link characteristics. Under such a scenario, routers are not in sync with current link conditions resulting in routing decisions that do not reflect the state of the network.

One development in radio-based and mobile networking is the Mobile Ad-hoc Network (MANET). A single MANET includes radios that can exchange data over a certain geographic area. They could be relatively short-range radios, or have ranges of dozens of kilometers, for example, or greater. They could even use satellites to relay their signals. Although the details of each type of MANET radio network may vary, many of the underlying networking concepts are the same.

One challenge in the design of MANETs is how best to merge the different worlds of IP routing and mobile radio while taking advantage of the strengths of both. In MANETs, mobile nodes typically communicate over wireless radio networks. Here the radio link quality can vary significantly (and suddenly) because of factors such as noise, fading, interference, and power fluctuation. In such dynamic environments, TCP/IP networking decisions, such as network convergence, route-cost calculation, and congestion avoidance can become problematic.

In one aspect of the invention, a network includes a flow control mechanism to reduce packet loss in a router-to-radio interface with transmission-on and transmission-off messages.

The transmission-on/off messages can replace credit update messages for significantly improved efficiency and reduced packet loss in high data rate conditions.

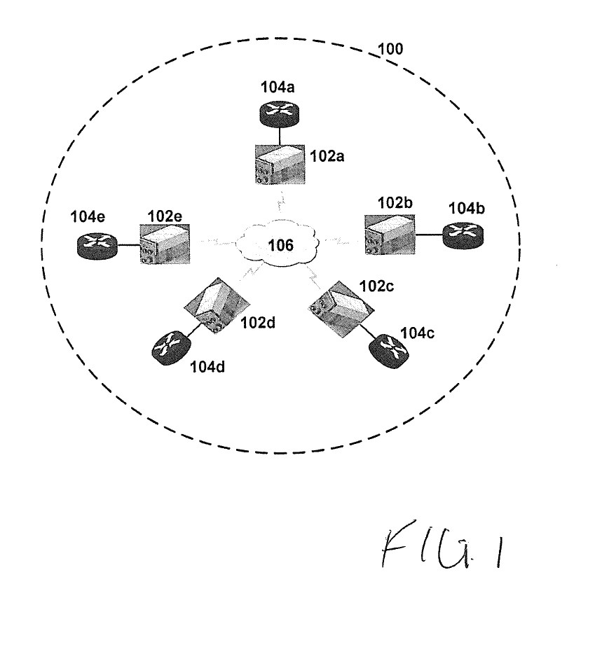

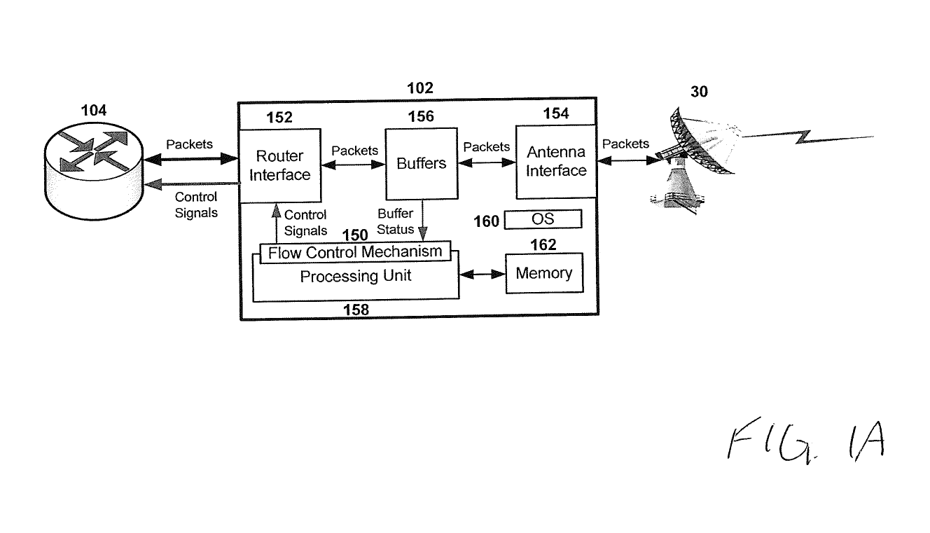

FIG. 1 shows an exemplary MANET network 100 having a router-to-radio flow control mechanism in accordance with exemplary embodiments of the invention. A series of routers 102a-e are connected to respective radios 104a-e, which are connected to a network 106. As can be seen, the routers 102 have a physical interface to the radios 104 to exchange data. As used herein, wireless networks communications/network radio (hereafter simply “radio”) interface with hardware/software machines that perform an IP routing function (hereafter simply “routers”) at the sub-network boundaries to form a contiguous network infrastructure.

To support the information interchange between the radios 104 and the routers 102, the physical interface (or at least, a limited set of interfaces) between routers and radios should be standardized. Also, there should be a standardized protocol for exchanging environmental information between routers 104 and radios 102.

In one embodiment, Ethernet provides the physical interface between routers 104 and radios 102. Ethernet is prevalent and inexpensive and can cover almost any range of bandwidth. However, if the router 104 connects to a radio 102 via a 100 Mbps Ethernet connection, and the radio 102 is only capable of transmitting at 3 Mbps, then there should be a way for the radio 102 to inform the router 104 that the actual bandwidth of the link is only 3 Mbps.

FIG. 1A shows an exemplary radio 102 having a flow control mechanism 150 in accordance with exemplary embodiments of the invention. The radio 102 includes a router interface 152 to send control signals to the router 104 including transmit on and transmit off signals, as described more fully below. An antenna interface 154 transmits wireless signals to an antenna 30 in a manner well known in the art. A buffer 156 stores packet data from the router for transmission by the antenna interface 154 and antenna 30. In one embodiment, the buffer 156 should be sized to store at least one packet since in some protocols, such as Ethernet, complete packets are sent. For example, if a transmission-off signal is sent by the radio 102 during packet transmission the complete packet will be sent since partial packets are not allowed.

The radio 102 can further include a processor 158 to generate the transmission-on and transmission-off signals in accordance with exemplary embodiments of the invention, as described more fully below. The processor 158 also controls overall operation of the radio 102 and user interface in a manner well known in the art. An operating system 160 and memory 162 can function with the processor 158 in a conventional manner.

The known RFC 5578 attempts to address communication between a radio and a router. It is understood that one of ordinary skill in the art fully understands RFC 5578, which is an IETF standard that defines PPPoE extensions for Ethernet-based communications between a router and a device, such as a mobile radio that operates in a variable bandwidth environment and has limited buffering capabilities. It is understood that the Point-to-Point Protocol over Ethernet (PPPoE) is a network protocol for encapsulating Point-to-Point Protocol (PPP) frames inside Ethernet frames and is available as an informational RFC 2516. The PPPoE extensions allow a radio to inform its partner router the effective bandwidth of the radio link(s), and thus, allow the router to make more intelligent decisions for keeping network traffic flowing quickly and efficiently. Unfortunately, under high data rate situations, this protocol will cause either performance degradation on routers due to frequent credit updates, or packet losses on radios due to insufficient buffer space.

For networking in MANET environments, RFC 5578 provides a number of features. PPPoE Credit-Based Flow-control allows a receiver (e.g., a radio in a MANET network) to control the rate at which a sender (e.g., a router) can transmit data during each PPPoE session. With this protocol, the sender should send data only up to the amount of traffic the receiver can process. Since the bandwidth of each radio link can vary significantly over time, and many radio transmission systems have limited buffering capabilities, this feature can minimize buffer overflow issues in the radio.

Another RFC 5578 feature includes Neighbor Up/Down Signaling. Routers can use PPPoE session establishment or termination signals from the radio to update routing topologies. Since MANETs are highly dynamic in nature, nodes may move in or out of radio range at a fast pace. Once receiving a neighbor up/down signal, the routing protocols, such as OSPF and EIGRP, can immediately establish a new adjacency for a new neighbor, or tear down an existing adjacency if a neighbor is lost. This provides network convergence by using link status signals generated by the radio.

A further RFC 5578 feature includes Link Quality Metrics Reporting. The quality of a radio link can directly impact the throughput and latency that router-to-router traffic can achieve.

This feature enables a radio to report (or a router to query) link quality metric information. Then, the router uses the received link information to update route costs and influence the route selection. The quality metrics may include maximum data rate, current data rate, latency, resources, etc. To reflect the dynamic changes of mobility and environment conditions, the radio may generate link quality metrics to the router when needed.

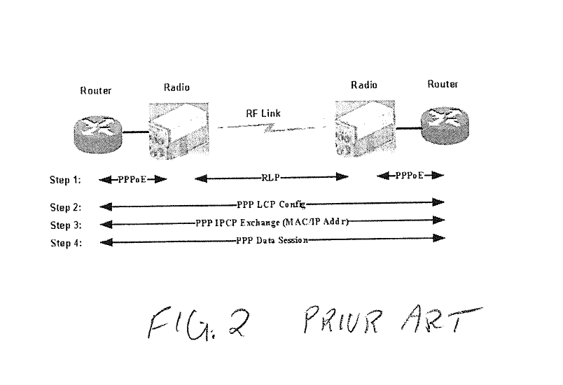

PPPoE has two distinct stages: A Discovery Stage and a PPP Session Stage. A radio detects the presence of a remote radio neighbor during the Discovery Stage. Once found, it establishes a radio link connection with the remote neighbor. After a complete path between two routers is formed, a PPP Session Stage begins. During this stage, credit grants are used to regulate the traffic flow between two ends. The concept is a node must grant credits to its peer before the peer can transmit packets to the granting node. A detailed description of these two stages is provided below and shown in FIG. 2.

PPPoE sessions are used between routers and radios. Each radio establishes point-to-point Radio Link Protocol (RLP) sessions with its neighbors. When the local client (radio) detects the presence of a remote radio neighbor, it initiates a PPPoE session with its local server (router). The radio also establishes a radio link connection with the remote radio over the point-to-point radio frequency (RF) link. The remote radio also establishes a PPPoE session with its local Server (router). By combining the two PPPoE sessions and the point-to-point RF link, a complete data path between two routers is formed.

Whenever a PPPoE session is established, the router opens a Point-to-Point Protocol (PPP) Link Control Protocol (LCP) session with the corresponding neighbor to negotiate PPP options. When the PPP LCP process is complete, the PPP IP Control Protocol (IPCP), as described in RFC 1661, initiates an exchange of layer 3 parameters between neighbor nodes. FIG. 2A shows the well-known OSI layer diagram. Included in this IPCP exchange is the router IP address. With the exchange of the IPCP IP addresses, each router inserts the remote IP address into its local routing tables. After the IPCP exchange, PPP data starts to flow from router to router.

As described in RFC 5578, to minimize the need for packet queuing in the radio, a router employs a credit granting mechanism that enables the radio to control the rate at which its partner router sends traffic. Each flow-control credit corresponds to the amount of PPP payload bytes that can be sent or received. A node must grant credits to its peer before the peer can transmit packets to the granting node. Credits received from a peer are added to a local running credit counter. The accumulated credits are decremented with each packet the node transmits to the peer. When the running counter reaches zero, the sending node must stop transmitting packets to the peer. To manage the credits that a node has granted, it too must maintain a running counter. With each PPP session packet received from the peer, the running counter is decremented. When the running counter reaches zero, no additional packets are expected. The node incrementally grants more credits to the peer to maintain packet flow. Packets received when granted credits have been exhausted are discarded. Note that once a credit has been granted, it must be honored.

One of the goals in the design of PPPoE Extension for credit flow and link metrics is to minimize the need for queuing in the radio. To achieve that goal, ideally all the packets received should be transmitted via RF link to its neighbor node immediately. However, it is possible that multiple radios may need to share the same transmission medium (e.g., a radio frequency channel). In this case each node can use only a part of its channel capacity being assigned to it. Time division multiple access (TDMA) is a commonly employed technology to manage medium access.

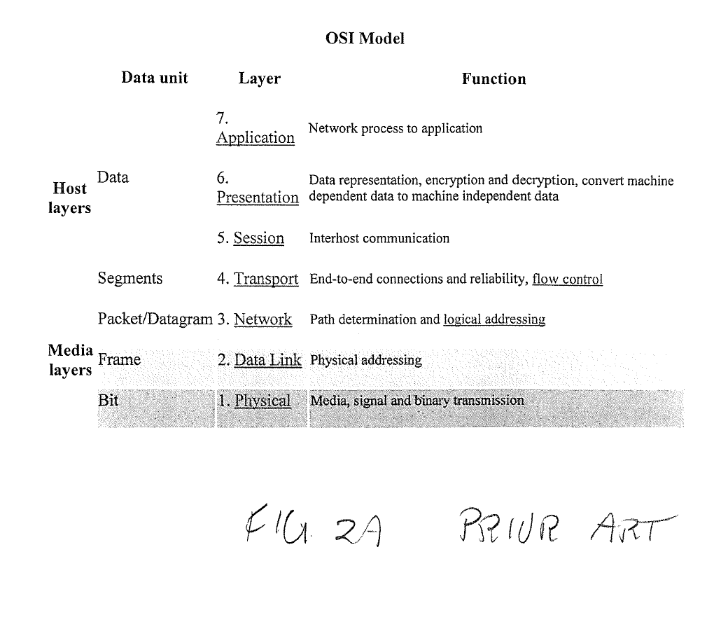

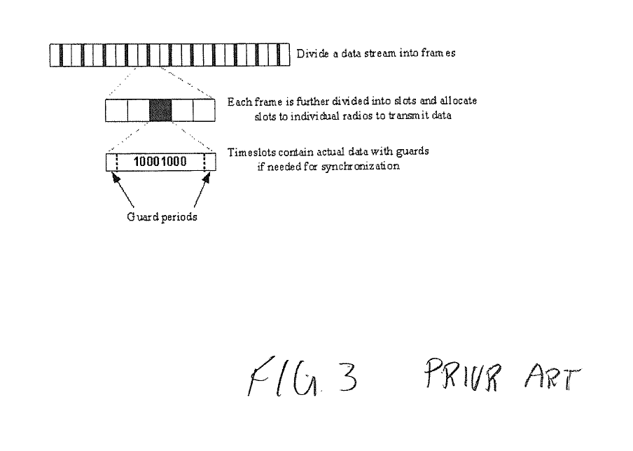

FIG. 3 shows how TDMA works. The data stream is divided into frames and those frames further divided into timeslots (e.g., 5 timeslots in this example) in a known manner. Then each slot is exclusively allocated to a radio which needs to transmit data. With TDMA, each radio must transmit its data packets only during its allocated timeslots in each frame. One issue is how to handle the data packets received during the unassigned slots. Note that a router has no way of knowing that its PPPoE client can transmit data only at the assigned timeslots. Thus, a router continues to send packets to its peer until either it does not have enough credits to transmit the next packet or its transmit buffer becomes empty.

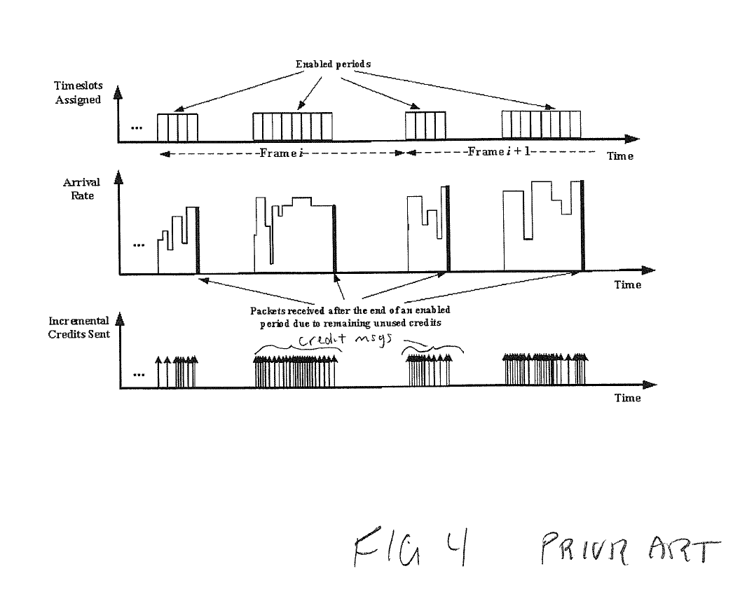

Given a timeslot assignment for a radio and a data stream, FIG. 4 shows how to regulate the traffic flow between router and radio by using incremental credits in accordance with RFC 5578. As stated above, once a credit has been granted, it must be honored. Consequently a radio must have a buffer large enough to hold all the allowable packets received during the off period. The buffer size cannot be less than the maximum outstanding credits a router is allowed to have. A FIFO (First In First Out) buffer may be an inappropriate configuration if the size is relatively large because the serialization effect may cause long queuing delays for mission-critical streams. Multi-queue structures may be a better choice to provide differentiated services in this scenario. To enforce the QoS policy, modern commercial routers provide multiple queues ranging in number from 2 to 256 in each interface. It may be that the buffer configuration in a radio interface should match the corresponding one in the partner router since a mismatch may cause the disruption in enforcing the QoS policy due to packet regrouping. The buffer in a radio interface can also be dynamically reconfigurable. A fixed structure design may not guarantee that both interfaces of a router-to-radio link always use the same queue configuration. While the dynamically reconfigurable buffer provides the best flexibility, it increases the design complexity and the administrative cost in managing these queues. After describing the challenges faced in having a large buffer, a small buffer may seem to be a more reasonable and feasible approach. However, a small buffer imposes a restriction on the maximum outstanding credits a router can have in order to avoid the buffer overflow on the radio side. To keep the traffic flow smoothly between a radio and its partner router, this approach implies that a radio must replenish its peer transmit credits fast enough to maintain packet flow. Note that there exists the processing overhead associated with a credit granting packet, e.g., parse the packet, update its working credit count, etc. Frequently incremental credits may result in more processing power being reserved for credit administration rather than for handling the real data traffic, not to mention the valuable bandwidth being consumed by credit granting packets.

For a given radio, assume the supported data rate of RF link is Rrf, the buffer size of the router facing interface is Srtr, and the value of incremental credits is Ci. Let Cmax be the maximum outstanding credits a PPPoE server, i.e., router, can have. By default, Cmax≦Rrf, i.e., a router should never transmit more data than what its peer can handle. Also, Ci≦Srtr, i.e., the incremental credits should never be larger than the buffer size to avoid the risk of buffer overflow.

Let Gpkt be the number of credit granting packets generated in a cycle. To support Rrf, Gpkt≧Rrf/Ci. The reason Gpkt may be larger than Rrf/Ci is because to maintain packet flow, a radio may send credits before its peer uses up its available credits. To minimize the granting packet count, Ci can be set as large as Srtr. In summary, given a RF link data rate, Cmax≦Rrf, Ci≦Srtr, and Ci×Gpkt≧Rrf.

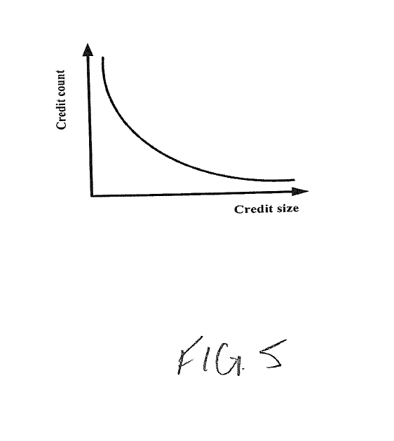

FIG. 5 shows the trade-off between credit size (Ci) and credit granting packet count (Gpkt) when Ci×Gpkt=Rrf. Assume Ci=Srtr. Given a data rate and buffer size, Table 1 below shows the number of credit granting packets needed at least in order to support the given data rate.

TABLE 1
Comparison of number of credit granting packets needed

| | Number of Credit Granting Packets | | | |
|---|---|---|---|---|
| Supported Data | Per Cycle (Gpkt) | | | |
| Rate (Rrf) | Srtr = 1M | Srtr = 2M | Srtr = 4M | Srtr = 8M |
| 40M | 40 | 20 | 10 | 5 |
| 80M | 80 | 40 | 20 | 10 |
| 120M | 120 | 60 | 30 | 15 |
| 160M | 160 | 80 | 40 | 20 |

As expected, the increase in buffer size reduces the number of granting packets required. However, the large buffer size causes long queuing delays for the mission-critical streams if a FIFO queue structure is used. The decrease in buffer size can either mitigate or completely eliminate the constraint in queue design. Unfortunately, it also causes more incremental credits being generated. Recall that with TDMA, each radio needs to transmit data packets during its allocated timeslots. Instead of being evenly spread out over a time period, these granting packets are sent only during the radio's enabled periods as showed in FIG. 4.

As described above, both PPPoE clients and servers need to manage credits so that clients know when they need to replenish server credits and servers can decide whether they can transmit packets. In addition, the credit information on both sides must be synchronized so that deadlock will not occur. Deadlock occurs when the client thinks its peer still has enough credits and is waiting for new packets to arrive while its peer stops transmitting packets due to insufficient credits. Depending on the computing power of the processors, the overhead associated with processing granting packets and credit tracking may overload the router while it is busy delivering packets. When this occurs, a router either momentarily stops transmitting data packets or cannot timely update its credit counter.

The credit-based solution described in RFC 5578 allows a PPPoE client (e.g., radio) to control the packet arrival rate by specifying the exact amount of data it can process at a given time. Ideally, this approach can minimize the buffer space required in the radio by manipulating the incremental credits and let the routers deal with the congestion situation when it occurs.

The RFC 5578 credit-based solution inadequately addresses the discrepancy in medium access technology between time-invariant throughput found in Ethernet and time-varying link capacity of the RF link. As described above, once a credit has been granted, it must be honored. The radio needs to have enough buffer space to hold the maximum outstanding credits of data its partner router may deliver during the off period. Also, the radio must replenish its peer credits fast enough so that it does not stay idle due to insufficient credits during the enabled period. It becomes very difficult to determine the right combination of buffer size and credit size because they have completely different constraints.

In accordance with exemplary embodiments of the invention, the credit granting message in RFC 5578 is replaced by a flow control mechanism in which transmission-on/transmission-off messages are transmitted between radios and attached routers. A transmission-on message is sent when the radio is ready to receive new packets. A transmission-off message is sent when the radio buffer is about to be full. Upon receiving a transmission-on signal, a router starts its packet delivery service at the configured line rate until either it receives a transmission-off signal from its peer or its transmit buffer becomes empty. Note that in Ethernet, the sender is not allowed to transmit a partial packet. Thus, upon receiving a transmission-off signal, the router will continue to deliver the current packet but suspend further packet transmission until a transmission-on signal is received. Because of this, to avoid unnecessary packet drops, the radio reserves adequate buffer space to hold packets currently in transit on the wire after sending a transmission-off signal to its peer.

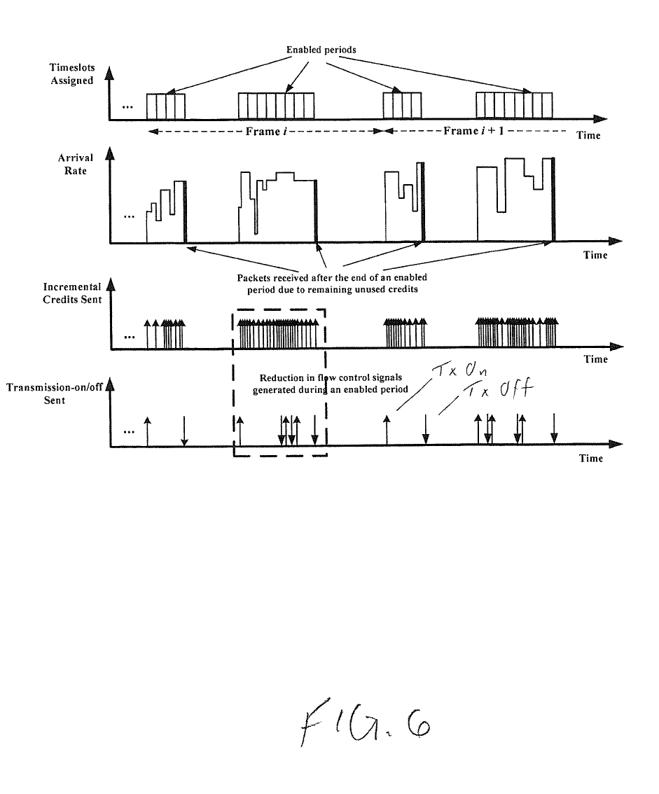

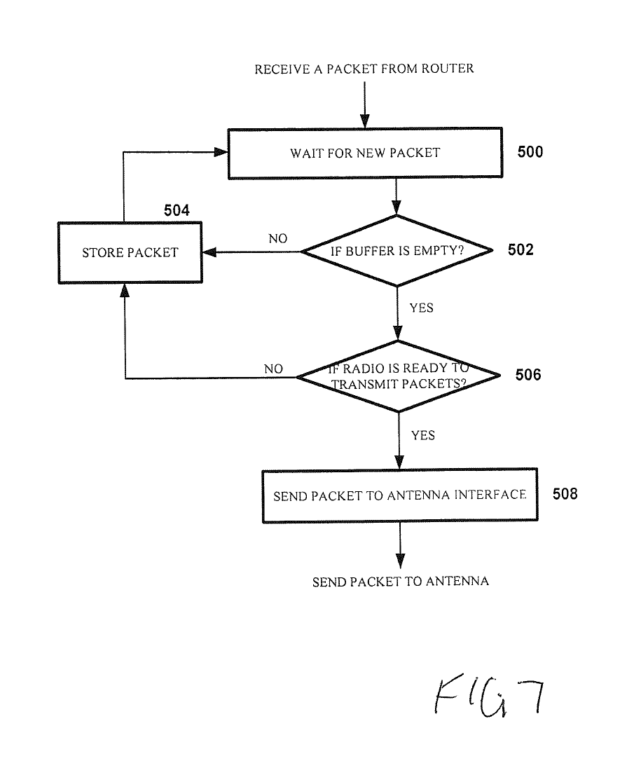

As shown in FIG. 6, which also includes FIG. 4 for comparison, transmission-on/off signals can be transmitted by the radio to control packet transmission.

Assume Srtr (radio buffer size)=Ci (incremental credits)=1 Mb and the arrival data rate is ranging from 40 Mb to 160 Mb for a given enabled period. Table 2 below shows the number of flow-control signals needed for both the original protocol and the inventive flow control mechanism. For the credit-based approach, the number is in proportion to the arrival rate. On the contrary, the number of packets in the inventive revised protocol is generally invariant to the arrival rate assuming the arrival rate is smaller than the output rate of RF link.

TABLE 2
Comparison of number of packets needed

Number of Packets Generated
Per One Enabled Period

| | Credit Based (Assume | |
|---|---|---|
| Arrival Rate | Ci = Srtr—1M | Transmission—On/Off |
| 40M | 40 | 2+ |
| 80M | 80 | 2+ |
| 120M | 120 | 2+ |
| 160M | 160 | 2+ |

Note it is assumed that only one pair of transmission-on and transmission-off signals are generated for each enabled period in this example. Additional on/off signals may be needed when the buffer overflow is about to happen due to momentary imbalance between the arrival rate from the Ethernet interface and the output rate of RF link.

In an exemplary embodiment, the inventive flow control mechanism is implemented in layer 3 (network layer in TCP/IP) protocol. In the Ethernet protocol, upon receiving the pause frame on a port, it must suspend the transmission of further Ethernet packets for a certain period of time and hence, the protocol disables the Ethernet port, thus stopping the data-flow. In one embodiment, exemplary embodiments of the invention enhance RFC 5578 by addressing certain shortcomings in RFC 5578. In accordance with RFC 5578, an Ethernet port is allowed to open multiple PPPoE sessions, i.e., able to communicate with multiple neighbors concurrently. Upon receiving a transmission-off signal, only the transmission of corresponding sessions will be impacted. Other PPPoE sessions can continue to operate as usual.

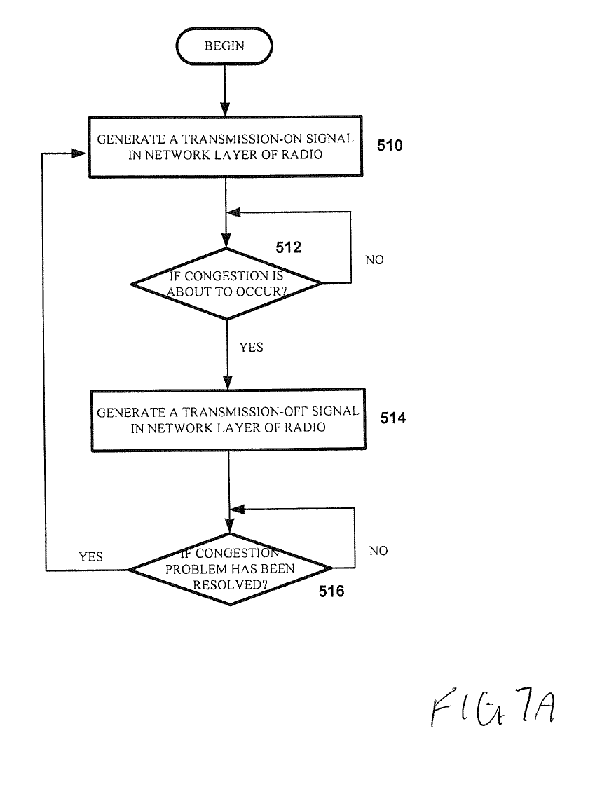

FIGS. 7 and 7A show an exemplary sequence of steps for implementing router-to-radio flow control in accordance with exemplary embodiments of the invention. Referring to FIG. 7, in step 500, the radio waits for a new packet from the router. Upon receiving a new packet, in step 502, the radio determines if the packet buffer is empty. If not, the radio stores the packet in step 504 and waits for a new packet in step 500. If so, in step 506, the radio determines whether the radio is ready to transmit the packet. If not, the packet is stored in step 504. If so, in step 508, the packet is sent to the antenna interface prior to transmission by the antenna.

FIG. 7A shows the generation of transmission-on signals and transmission-off signals by the radio to control packet flow from the router. In step 510, a transmission-on signal is generated in the network layer of the radio and sent to the router to inform the router that the radio can receive packets. In step 512, the radio continuously determines whether congestion is about to occur. When the radio determines that congestion is about to occur, in step 514, the radio generates a transmission-off signal in the network layer for transmission to the router. In step 516, the radio continuously determines whether the congestion has been resolved. If so, processing continues in step 510 to generate a new transmission-on signal to inform the router to send packets.

It is understood that the inventive flow control mechanism reduces control signal traffic and eliminates the overhead associated with credit tracking and processing of granting packets. Even though the credit-based message is replaced by transmission-on/off signals, the neighbor up/down signaling and link quality metrics reporting functions described in RFC 5578 remain unchanged. Thus, routers can still use PPPoE session establishment or termination signals from the radio to update routing topologies and the received link quality information, such as the current supported data rate, to update route costs and influence the route selection.

Exemplary embodiments of the invention are useful in mobile ad hoc networks, for example, which are emerging as a means to deliver IP-based data, voice, and video to users who are operating beyond the reach of traditional fixed-network infrastructure. While mobile networking offers a compelling advantage, it also poses some challenges, such as merging IP routing and mobile radio technologies efficiently. It is understood that any suitable protocol can be used to meet the needs of a particular embodiment. In one embodiment, CDMA can be used to control packet transmission.

The inventive flow control mechanism regulates bandwidth usage between routers and radios to eliminate packet loss and/or performance problems with RFC 5578 and removes the requirement for resource tracking by the routers and radios, which dramatically reduces the flow-control signals generated by the radios. As compared to the number of credit granting packets generated in the credit-based RFC 5578 approach in proportion to the arrival data rate, only one pair of on and off signals are needed for the inventive flow control mechanism, which is invariant to the arrival rate assuming the arrival rate is smaller than the output rate.

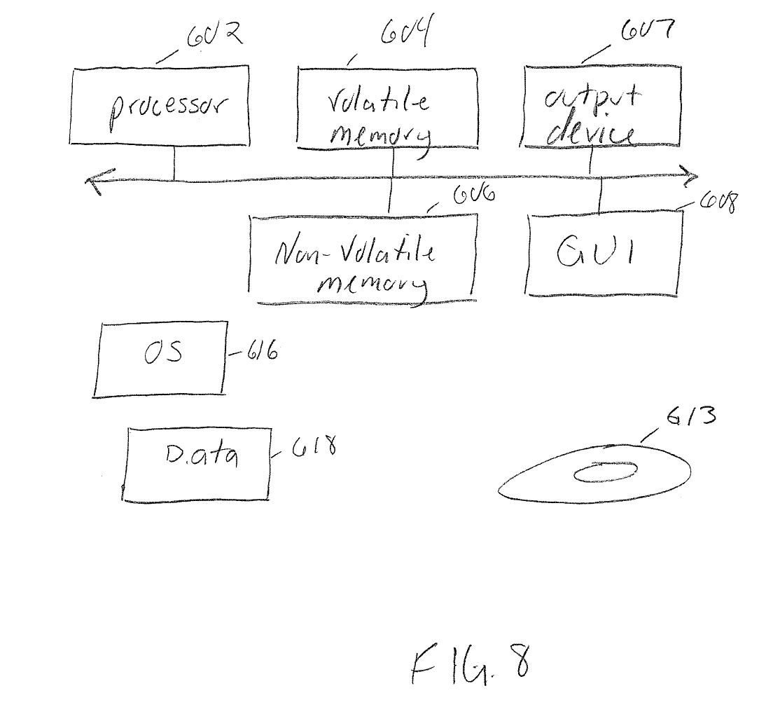

Referring to FIG. 8, a computer includes a processor 602, a volatile memory 604, a non-volatile memory 606 (e.g., hard disk), an output device 607 and a graphical user interface (GUI) 608 (e.g., a mouse, a keyboard, a display, for example). The non-volatile memory 606 stores computer instructions 612, an operating system 616 and data 618. In one example, the computer instructions 612 are executed by the processor 602 out of volatile memory 604 to perform processing, as described above. In one embodiment, an article 613 comprises stored non-transitory instructions on a computer-readable medium.

It is understood that exemplary flow control processing shown and described herein is not limited to use with the hardware and software of FIG. 8; the processing may find applicability in any computing or processing environment and with any type of machine or set of machines that is capable of running a computer program, and/or operating in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices.

The system may be implemented, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language, and/or burned into firmware. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, removable flash memory, or magnetic diskette) that is readable by a general or special purpose programmable computer for configuring and operating the computer when the storage medium or device is read by the computer to perform processing.

The exemplary flow control processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method, comprising:
transmitting, from a radio, over a router-to-radio interface, a first transmission-on signal indicating to a router that data packets can be sent to the radio for transmission in a network; and
transmitting, from the radio over the router-to-radio interface, a first transmission-off signal indicating to the router that data packet transmission should be suspended until receipt of a second transmission-on signal, wherein the first transmission-on signal and the first transmission-off signal are generated in a network layer of the seven-layer OSI model.

2. The method according to claim 1, further including storing, in the radio, a remainder of a packet transmitted by the router after the first transmission-off signal was transmitted by the radio.

3. The method according to claim 1, further including buffering data from the router for transmission to a radio.

4. The method according to claim 3, further including sizing a buffer for buffering the data from the router to receive complete packets.

5. The method according to claim 1, further including configuring the radio for Mobile Ad-hoc Network (MANET) operation.

6. The method according to claim 1, wherein the first transmission-off signal indicates that a buffer in the radio will overflow.

7. A communication system, comprising:
a radio comprising:
a router interface to interface with a router;
a buffer to buffer data from the router;
an antenna interface to receive data from the buffer for wireless transmission by an antenna; and
a flow control mechanism to generate a first transmission-on signal indicating to the router that data packets can be sent to the radio and a first transmission-off signal indicating to the router that data packet transmission should be suspended until receipt of a second transmission-on signal, wherein the flow control mechanism is located in a network layer of the seven-layer OSI model.

8. The system according to claim 7, wherein the communication system comprises a Mobile Ad-hoc Network (MANET) network.

9. The system according to claim 7, wherein the buffer is sized to store complete packets.

10. The system according to claim 7, wherein the first transmission-off signal indicates that a buffer in the radio will overflow.

11. An article, comprising:
computer readable medium including non-transitory stored instructions that enable a machine to perform:
transmitting, after receiving from a radio over a router-to-radio interface, a first transmission-on signal indicating to a router that data packets can be sent to the radio for transmission in a network; and
transmitting, after receiving from the radio over the router-to-radio interface, a first transmission-off signal indicating to the router that data packet transmission should be suspended until receipt of a second transmission-on signal, wherein the first transmission-on signal and the first transmission-off signal are generated in a network layer of the seven-layer OSI model.

12. The article according to claim 11, further including instructions for storing, in the radio, a remainder of a packet transmitted by the router after the first transmission-off signal was transmitted by the radio.

13. The article according to claim 11, further including instructions for buffering data from the router for transmission to a radio.

14. The article according to claim 13, further including instructions for sizing a buffer for buffering the data from the router to receive complete packets.

15. The article according to claim 11, further including instructions for configuring the radio for Mobile Ad-hoc Network (MANET) operation.

16. The article according to claim 11, wherein the first transmission-off signal indicates that a buffer in the radio will overflow.
